(19) United States
(12) Patent Application Publication
(10) Pub. No.: US 2008/0124447 A1
(43) Pub. Date: May 29, 2008

(54) FOOD RECIPE - CHESAPEAKE BAY BRATWURST

(76) Inventor: Bart Shortall, Denton, MD (US)

Correspondence Address: MILES & STOCKBRIDGE PC, 1751 PINNACLE DRIVE, SUITE 500, MCLEAN, VA, 22102-3833, US

(21) Appl. No.: 11/564,511

(22) Filed: Nov. 29, 2006

(51) Int. Cl. A23L 1/317; A23L 1/31

(52) U.S. Cl. 426/643; 426/105

(57) ABSTRACT

A flavored food product based on the combination of meat and crab. The present invention combines the popularity of bratwurst, with the popular flavor of crab. An embodiment of the present invention may be referred to as crab seasoned bratwurst. An alternate embodiment of the present invention may be referred to as hot crab seasoned bratwurst. The bratwurst of the present invention may be based on pork, veal, venison, or a combination of two or more meats, and crab.

### BACKGROUND

### Field of the Invention

The present invention relates generally to sausage products and more particularly to a crab flavored bratwurst.

Bratwurst has become a popular meal these days and is often the food of choice at one's favorite outdoor activities, such as a backyard picnic or ballgame. It is also a favorite meal, and Bratwurst can be found cooking on outdoor grills or simmering in pans of water all around the world.

In addition to bratwurst, another highly popular food item is crab. The Chesapeake Bay blue crab is in particular cherished for its taste. This famous food item, indigenous to the Eastern Shore of Maryland, also enjoys worldwide popularity. Because of the blue crab's possible extinction, the swimming crab, having a texture and taste similar to the blue crab has been developed by the Phillips Seafood Company.

### SUMMARY

The present invention presents a flavored meat product by combining meat with crabmeat. This embodiment of the current invention, described herein, will be referred to as crab seasoned bratwurst. The crab seasoned bratwurst may be pork based, but other meats are suitable including veal, venison, and mixtures of each. Batches of the flavored meat product may be stuffed into casing and formed in links.

### BRIEF DESCRIPTION OF THE DRAWINGS

The accompanying drawings are incorporated in and constitute a part of the specification.

FIG. 1 shows a product label illustrating an embodiment of the invention.

FIG. 2 shows a nutrition label associated with the embodiment of the invention in FIG. 1 and a listing of its associated ingredients.

FIG. 3 shows an alternate embodiment of the invention, as illustrated on a product label.

FIG. 4 shows a nutrition label associated with the embodiment of the invention in FIG. 3 and a listing of its associated ingredients.

### DETAILED DESCRIPTION

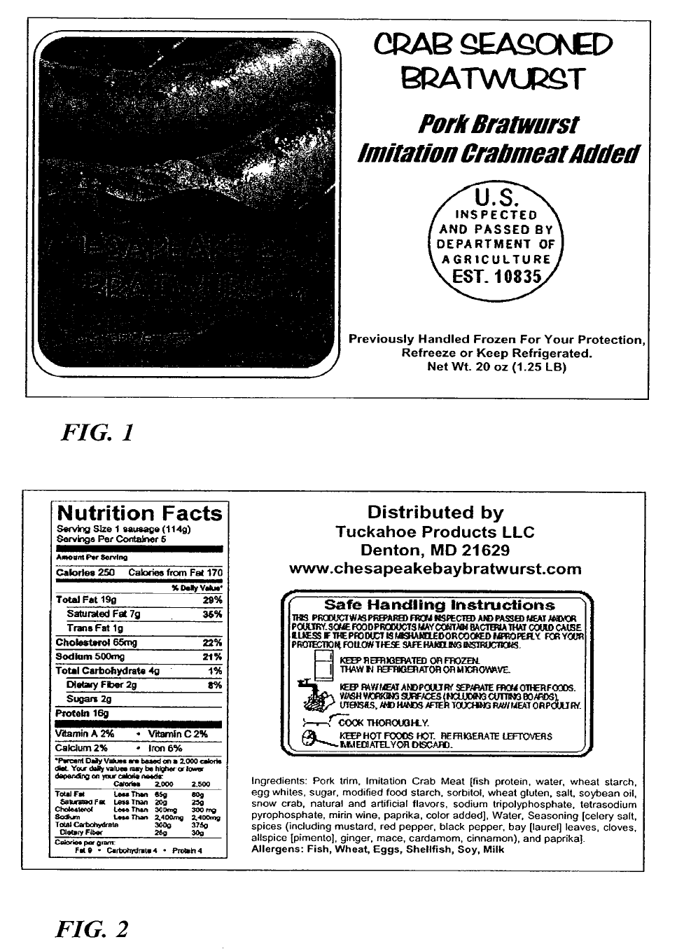

An exemplary embodiment of the bratwurst of the current invention is shown in FIG. 1 and comprises a casing forming an outer shell that is stuffed with preselected ingredients. The preferred ingredients or formulation which makes up the stuffing includes, in approximate percentages, 84.0% meat trimmings, 16.0% imitation crabmeat, 2.9% crab or fish seasoning, and 4.5% free water. All percentages are based on the total weight of the meat trimmings and imitation crabmeat only. For example, in a 25-pound batch, the meat trimmings comprise 21 pounds of meat (e.g., pork, veal, venison, or mixtures thereof) and 4 pounds of crabmeat. Other ingredients include 0.72 pounds of seasoning and 1.125 pounds of free water. Percentages may be varied, depending on individual tastes. The meat content, however, will be generally between 80% and 85%, approximately, of the total weight of the meat trimmings and crabmeat batch.

As can be seen from the list of ingredients shown in FIG. 2, other additives which may be added as desired include salt; flavorings, such as celery salt and paprika; spices, such as mustard, red pepper, black pepper, bay leaves, cloves, allspice, ginger, mace, cardamom, and cinnamon; thickeners, such as wheat gluten and tetrasodium pyrophosphate; binders, such as wheat starch, modified food starch, egg whites, and soybean oil; sweeteners, such as natural or artificial sugar and sorbitol; coloring agents, such as paprika, mirin wine, and dyes; preservatives, such as sodium tripolyphosphate; and vitamins. It will be noted that some substances, such as paprika, fall under two or more of the above classes of additives.

A number of samples of the crab seasoned bratwurst of the present invention were prepared generally as follows. The crab content may vary between 10% and 25%, approximately. Seasoning content may vary between 2% and 4%, approximately. The free water content may vary between 2.5% and 10%, approximately. The meat is preferably derived from pork trimmings; however, other meat such as veal and deer meat may also be used, independently or in combination.

Boneless meat, at a temperature between −5 and 38 degrees Celsius, is placed in a chopper and is coarse ground. The ground meat is then transferred to a mixer/grinder where it is combined with water, crabmeat, and crab seasoning. Imitation crabmeat, such as Oyster Bay Supreme Flakes sold by Harbor Seafood, may be used in place of fresh crabmeat. Commercial fish or crab seasoning, such as OLD BAY® Seasoning sold by McCormick & Company, Incorporated, may be used. The prepared batch may be packaged in suitable containers for distribution to food outlets. Portions of the batches may also be stuffed and linked in natural casings, using a stuffer and linker, and packaged for distribution as crab seasoned bratwurst links. Alternatively, the casings can be made of collagen or cellulose.

FIG. 2 shows a nutrition label associated with the embodiment of the invention in FIG. 1. The nutrition label includes information in terms of gram weight (g) and percentages of the United States Food and Drug Administration recommended Daily Value (DV), based on a 2,000 calorie diet. According to the nutrition label, a 114 g serving size equals approximately one bratwurst link or sausage and contains approximately 250 calories, 170 of which are from fat; 19 g of total fat (29% DV), including 7 g of saturated fat (35% DV) and 1 g of trans fat; 65 mg of cholesterol (22% DV); 500 mg of sodium (21% DV); 4 g of total carbohydrate (1% DV), including 2 g of dietary fiber (8% DV) and 2 g of sugar; 16 g of protein; 2% DV Vitamin A; 2% DV Vitamin C; 2% DV Calcium; and 6% DV Iron.

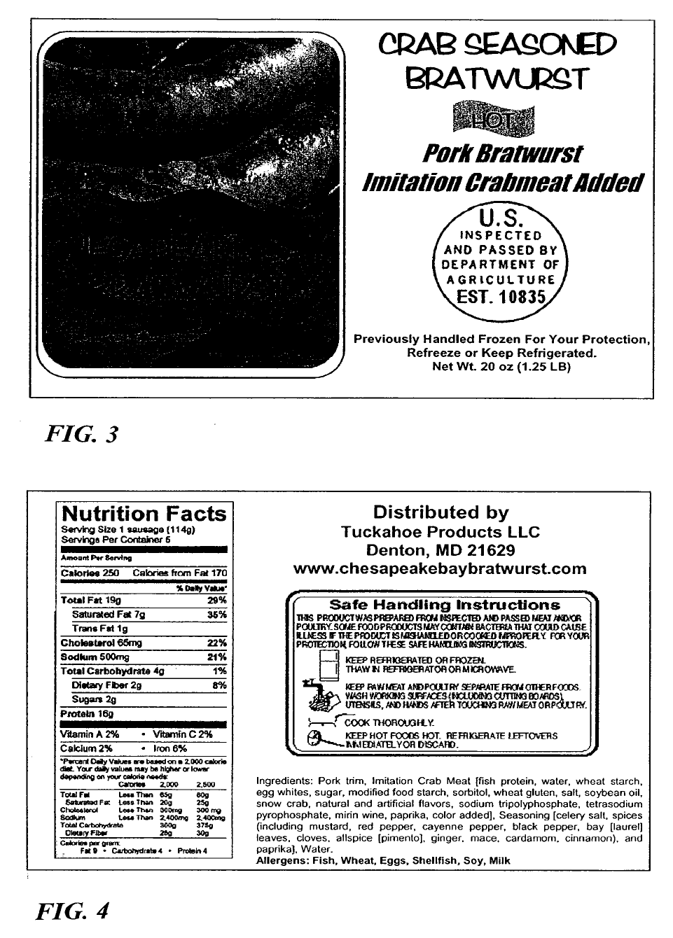

An alternate embodiment of the bratwurst of the current invention is shown in FIG. 3. This embodiment includes a “hot” flavor variation of the current invention. The formulation of the bratwurst composition includes 84.0% pork, 16.0% imitation crabmeat, 2.9% crab seasoning, 4.5% free water, and 1.1% cayenne pepper. All percentages are based on the total weight of the pork and imitation crabmeat only.

In a variation of the foregoing embodiment, venison or veal may be substituted for pork in the meat portion of the bratwurst composition.

Further variations may include mixtures of pork, veal, and deer meat. Suitable mixtures may include variation of the pork, veal, and venison content within the following ranges, with the relative percentages of each adjusted accordingly to total 100% of the meat portion of the bratwurst composition:

a. 30-70% pork and 30-70% veal

b. 30-70% pork and 30-70% venison

c. 20-50% pork, 20-50% veal, and 20-50% venison.

Other additives which may be added as desired are shown in a list of ingredients in FIG. 4 and include salt; flavorings, such as celery salt and paprika; spices, such as mustard, red pepper, black pepper, bay leaves, cloves, allspice, ginger, mace, cardamom, cinnamon, and cayenne pepper; thickeners, such as wheat gluten and tetrasodium pyrophosphate; binders, such as wheat starch, modified food starch, egg whites, and soybean oil; sweeteners, such as natural or artificial sugar and sorbitol; coloring agents, such as paprika, mirin wine, and dyes; preservatives, such as sodium tripolyphosphate; and vitamins. It will be noted that some substances, such as paprika, fall under two or more of the above classes of additives.

Boneless meat, at a temperature between −5 and 38 degrees Celsius, is placed in a chopper and is coarse ground. The ground meat is then transferred to a mixer/grinder where it is combined with water, crabmeat, and crab seasoning. While imitation crabmeat, such as Oyster Bay Supreme Flakes sold by Harbor Seafood, is used in this embodiment, fresh crabmeat may be used as an alternative. Commercial fish or crab seasoning, such as OLD BAY® Seasoning sold by McCormick & Company, Incorporated, may be used. The prepared batch may be packaged in suitable containers for distribution to food outlets. Portions of the batches may also be stuffed and linked in natural casings, using a stuffer and linker, and packaged for distribution as crab seasoned bratwurst links. Alternatively, the casings can be made of collagen or cellulose.

FIG. 4 shows a nutritional label associated with the embodiment of the invention in FIG. 3. The nutrition label includes information in terms of gram weight (g) and percentages of the United States Food and Drug Administration recommended Daily Value (DV), based on a 2,000 calorie diet. According to the nutrition label, a 114 g serving size equals approximately one bratwurst link or sausage and contains approximately 250 calories, 170 of which are from fat; 19 g of total fat (29% DV), including 7 g of saturated fat (35% DV) and 1 g of trans fat; 65 mg of cholesterol (22% DV); 500 mg of sodium (21% DV); 4 g of total carbohydrate (1% DV), including 2 g of dietary fiber (8% DV) and 2 g of sugar; 16 g of protein; 2% DV Vitamin A; 2% DV Vitamin C; 2% DV Calcium; and 6% DV Iron.

While the above examples use imitation crabmeat, in a preferred but more expensive embodiment of the current invention, Chesapeake Bay blue crab meat or the crabmeat from the recently developed and farmed swimming crab may be used to form the bratwurst of the present invention.

The bratwurst of the present invention may be cooked in a variety of ways, to include grilling, boiling, frying, and broiling, and maybe served separately, with vegetable side dishes, or as a sandwich in a roll or with bread slices.

The bratwurst of the present invention provides a combination of flavors that may add variety to the products made by the sausage industry and not heretofore available. The aroma of this bratwurst may give the consumer the sensation of fresh crab cakes frying on the stove, while the flavor of crab enhances the taste of the bratwurst.

It is, therefore, apparent that there is provided in accordance with the present invention, a bratwurst having, among other things, a crab seasoned flavor, and a method for producing such. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A crab flavored bratwurst comprising about 70-90% meat, 10-30% crab, 2-4% seasoning, and 2.5-10% free water, wherein the percentages are based on the total weight of the meat and crab only.

2. The crab flavored bratwurst of claim 1, wherein the meat is selected from the group comprising pork, veal, and venison.

3. The crab flavored bratwurst of claim 2, wherein the meat comprises a mixture that falls approximately within the following range:
30-70% pork; 70-30% veal.

4. The crab flavored bratwurst of claim 2, wherein the meat comprises a mixture that falls approximately within the following range:
30-70% pork; 70-30% venison.

5. The crab flavored bratwurst of claim 2, wherein the meat comprises a mixture that falls approximately within the following range:
20-50% pork; 20-50% veal; 20-50% venison.

6. A method for making a crab seasoned bratwurst product comprising:
preparing a batch of meat cuttings selected from the group comprising pork, veal, and venison;
adding to the batch a predetermined quantity of crabmeat, seasoning, and water; and
combining the meat cuttings, crabmeat, seasoning, and water in a mixer/grinder to form a batch of the crab seasoned bratwurst product.

7. A method as set forth in claim 6, wherein the bratwurst product comprises about 10-30% crabmeat, based on the total weight of the meat cuttings and crabmeat only.

8. A method as set forth in claim 7, wherein the crabmeat is selected from the group comprising Chesapeake Bay blue crab, swimming crab, and imitation crab meat.

9. A method as set forth in claim 8, wherein the bratwurst product comprises about 70-90% meat cuttings, based on the total weight of the meat cuttings and crabmeat only.

10. A method as set forth in claim 9, wherein the meat cuttings comprise approximately 84.0% of the batch, and the crab meat comprises approximately 16.0% of the batch, the percentages being based on the total weight of the meat trimmings and crabmeat, exclusive of other ingredients.

11. A method as set forth in claim 10, wherein the prepared batch of bratwurst product is fed into a stuffer and linker by which links of the product are formed.
